(19) United States
(12) Patent Application Publication
(10) Pub. No.: US 2005/0229379 A1
(43) Pub. Date: Oct. 20, 2005

(54) Multilayered gas sensor element

(75) Inventor: Masashi Totokawa, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/104,663

(22) Filed: Apr. 13, 2005

(30) Foreign Application Priority Data
Apr. 15, 2004 (JP) 2004-120681

(51) Int. Cl. G01N 27/26

(52) U.S. Cl. 29/592.1; 204/424; 204/431

(57) ABSTRACT

A method for manufacturing a multilayered gas sensor element including plural thin layers is provided. The method comprises applying, onto a substrate in a pattern, a dispersion of nano-particles of a desired type of material in a dispersion medium along with a dispersant to provide a thin green layer of the nano-particles, repeating the above procedure using a different type of material until a desired number of green layers necessary for making a sensing unit on the substrate are stacked on the substrate, and sintering the stacked green layers at one time or one by one after formation of a green layer.

### CROSS-REFERENCE TO RELATED APPLICATION

This application is based upon and claims the benefit of priority from earlier Japanese Patent Application No. 2004-120681 filed on Apr. 15, 2004, the description of which being incorporated herein by reference.

### BACKGROUND OF THE INVENTION

1. Field of the Invention

This invention relates to a method for manufacturing a multilayered gas sensor element wherein very thin layers are stacked on a substrate.

2Related Art

For the manufacture of a multilayered gas sensor element of a stacked type, there is known a so-called sheet stacking method wherein ceramic materials are formed into sheets, followed by subsequent stacking thereof.

The performances recently required for such sheet-stacked gas sensor elements include faster responsiveness and ultra-early development of sensing activity. With the manufacture of sheet-stacked gas sensor element, a difficulty is involved in thinning individual layers. Thus, limitation is placed on the responsiveness and ultra-early development of sensing activity.

In order to overcome the above problem, Japanese Published Unexamined Application Nos. 06-201642 and 07-055765 propose methods of forming individual layers as being thin according to a sputtering technique.

As is well known in the art, sputtering is a process that is performed in vacuum and requires quite a long time for deposition. Thus, this technique may not be high in productivity. For instance, it may, in some case, take about one hour before deposition of a 1 μm thick layer.

### SUMMARY OF THE INVENTION

It is accordingly an object of the invention to provide a method for manufacturing a multilayered or sheet-stacked gas sensor element having ultra-early development of sensing activity and high responsiveness, with high precision and at low costs.

It is another object of the invention to provide a method for manufacturing a sheet-stacked gas sensor element, with which a multifunctional sensor element can be readily manufactured.

In order to achieve the above objects, there is provided a method for manufacturing a multilayered gas sensor element including plural thin layers, the method comprising applying, onto a substrate in a pattern, a dispersion of nano-particles of a desired type of material in a dispersion medium along with a dispersant, which allows dispersion of the nano-particles, to provide a thin green layer of the nano-particles, repeating the above procedure using a different type of material until a desired number of green layers necessary for making a sensing unit on the substrate are stacked on the substrate, and sintering the stacked green layers.

This method is advantageous in that because the nano-particles are used to provide a thin layer, the time required for the layer formation can be shortened. The use of nano-particles permits easy fabrication of a thin layer on the order of several micrometers. In addition, the nano-particles can be readily sintered at relatively low temperatures of 1000 to 1350° C.

The resulting gas sensor element made of a plurality of thin layers on a substrate is so small in volume and heat capacitance that the element is able to arrive at an activation temperature at which a gas concentration can be sensed relatively immediately after commencement of heating. As a matter of course, because of the small volume of the gas element, a gas to be measured can arrive at the inside of the element within a short time, thus such an element being excellent in responsiveness.

As will be described in more detail, the sensor element can be made of plural thin layers, a multilayered gas sensor element having a multicell arrangement can be made in an easy way, thus leading to the fabrication of a multifunctional element.

The patterning of a dispersion allows a green sheet or layer of nano-particles to be formed in a desired size, thus enabling one to fabricate an element having good dimensional accuracy. This eventually leads to a multilayered gas element of high precision.

As will be apparent from the above description, according to the method of the invention, there can be obtained a sensor element which ensures ultra-early development of sensing activity, high responsiveness, high precision of the element, and low manufacturing costs, and also allows the manufacture of a multifunctional element.

### BRIEF DESCRIPTION OF THE DRAWINGS

FIG. 1 is an illustrative view showing a multilayered gas sensor element according to a first embodiment of the invention;

FIG. 2 is an illustrative view of a dispersion of nano-particles in a liquid medium according to the first embodiment;

FIG. 3 is an illustrative view of a dispersion being sprayed from an inkjet nozzle according to the first embodiment;

FIG. 4 is an illustrative view of the state of nano-particles sprayed on a substrate according to the first embodiment;

FIG. 5 is a schematic top view illustrating a substrate on which only a single green layer is formed according to the first embodiment;

FIG. 6 is a schematic perspective view illustrating a substrate on which a single green layer is formed as in FIG. 5;

FIG. 7 is an illustrative view of a substrate on which plural green layers are formed according to the first embodiment;

FIG. 8 is an illustrative view of a dispersion being sprayed against green layers to form an shielding layer according to the first embodiment;

FIG. 9 is an illustrative view of a green layer that serves as a shielding layer according to the first embodiment;

FIG. 10 is a cross-sectional view illustrating a stacked gas sensor element of a two-cell type for measuring a NOx concentration according to a second embodiment; and

FIG. 11 is a cross-sectional view illustrating a stacked gas sensor element of a two-cell type for measuring a NOx concentration according to a third embodiment.

### PREFERRED EMBODIMENTS OF THE INVENTION

In the manufacture of a layer-stacked or multilayered gas sensor element according to the invention, a desired number of dispersions containing different types of materials in the form of nano-particles are sequentially applied onto a substrate to provide the desired number of green layers which are, respectively, made of materials selected for use as a sensor element. Thereafter, these green layers are sintered at one time to obtain a sensing unit having plural, sintered, thin layers bonded together. Alternatively, a green layer may be formed on a substrate and then sintered, followed by repeating the formation and sintering of another type of green layer on the sintered layer until a desired number of layers are formed on the substrate as sintered.

In particular, with the former case, in order to prevent adjacent layers from being mixed at the interface thereof, an upper green layer is formed after drying of a lower green layer to an extent sufficient to prevent the mixing as mentioned above.

Reference is now made to dispersions used to form plural layers necessary for making a sensing unit on a substrate.

The dispersion used in the practice of the invention should contain nano-particles dispersed in a liquid medium along with a dispersant for the nano-particles. The term “nano-particles” used herein is intended to mean very fine particles having a particle size of 3 nm to 50 nm. When the size is smaller than 3 nm, a difficulty is involved in the preparation thereof. Even if preparation is possible, a yield thereof becomes very low. On the contrary, when the size is larger than 50 nm, a dense layer is very unlikely to obtain.

The nano-particles used in the practice of the invention can be prepared by any of liquid phase and vapor phase methods. According to the vapor phase method, a starting material is evaporated in vacuum or in an atmosphere of an inert gas, and the resulting clusters of gas molecules are collected to obtain nano-particles.

When using a liquid phase method, a starting material is dissolved in a solution so that the molecules of the starting material are mutually associated in colloidal form or precipitated, followed by collection to obtain nano-particles.

In the dispersion, the nano-particles are dispersed in liquid mediums such as water, alcohols, alkane compounds or mixtures thereof. From the standpoint of the dispersion stability of nano-particles, a most suitable medium should be chosen depending on the type of material used for nano-particles.

Aside from the liquid medium and nano-particles, the dispersion should contain a dispersant. The addition of dispersant is for the reason that when nano-particles are merely dispersed in a liquid medium, they are very liable to flocculate. To avoid this, a dispersant is added so as to allow individual nano-particles to exist as discrete particles in the dispersion as will be particularly described hereinafter. Examples of the dispersant include amino group-bearing compounds such as alkaneamines or the like, and sulfanyl group-bearing compounds such as alkanethiols and the like. In order to permit nano-particles to be distinctly separated from one another in the dispersion, the amount of a dispersant is preferably within a range of 0.1 to 30 wt %, preferably 1 to 10 wt %, based on the liquid medium. Less amounts may lead to instable dispersion. On the contrary, larger amounts may increase viscosity of the resulting dispersion, thereby causing inconvenience in a subsequent application step. In addition, the nano-particles are preferably present in the dispersion within a range of 1 to 50 wt %.

In order to further facilitate good dispersability and dispersion stability of a dispersion, a dispersant scavenger may be added. The scavenger is added to the dispersion so as to react with a dispersant and permit the dispersant to be separated from the particles. Examples of such a scavenger include organic acid anhydrides or organic acids, typical of which are formic acid, acetic acid, propionic acid and the like.

According to the method of the invention, the dispersion prepared in such a manner as set out above is applied onto a substrate in a pattern. The patterning techniques useful in the invention include ink jet printing, dispenser printing, screen printing and the like. Especially, when ink jet printing is used for the patterning, it is preferred to control a viscosity of a dispersion in the range of 0.5 to 20 mPa.S. When using a dispenser printing, a high viscosity is conveniently used. With screening printing, it is preferred to use a higher viscosity than with the case using a dispenser. The viscosity should be appropriately determined while testing dispersions of different viscosities.

The types of materials for the nano-particles are properly determined depending on the types of thin layers to be imparted with functional properties required for an intended multilayered gas sensor element according to the invention. A specific arrangement of the gas sensor is described hereinafter, and if, for example, a solid electrolyte layer made of zirconia is necessary for a thin layer, nano-particles made of zirconia can be prepared according to the liquid phase or vapor phase method and used for this purpose.

The multilayered gas sensor element according to the invention is more particularly described with respect to a structure thereof.

One specific and preferred instance of a plurality of thin layers useful as a gas sensor includes, on a substrate, a first diffusion resistance layer, a first electrode layer, a first solid electrolyte layer, a second electrode layer, and a second diffusion resistance layer arranged in this order. The sensor of this arrangement is particularly useful for sensing an oxygen gas.

Another typical and preferred instance includes, on a substrate, a third electrode layer, a second solid electrolyte layer, a fourth electrode layer, a first diffusion resistance layer, a first electrode layer, a first solid electrolyte layer, and a second diffusion resistance layer arranged in this order. This arrangement is particularly suitable for use as a sensor for NOx gas.

Moreover, a specific and preferred arrangement of a gas sensor includes, on a substrate, a third electrode layer, a semiconductor layer, a first diffusion resistance layer, a first electrode layer, a first solid electrolyte layer, a second electrode layer, and a second diffusion resistance layer. This arrangement is particularly suitable for use as a sensor for CO gas.

These types of gas sensors are all fabricated according to the method of the invention and have characteristic features of ultra-early development of sensing activity, high responsiveness and high precision, along with low fabrication costs.

### Embodiment 1

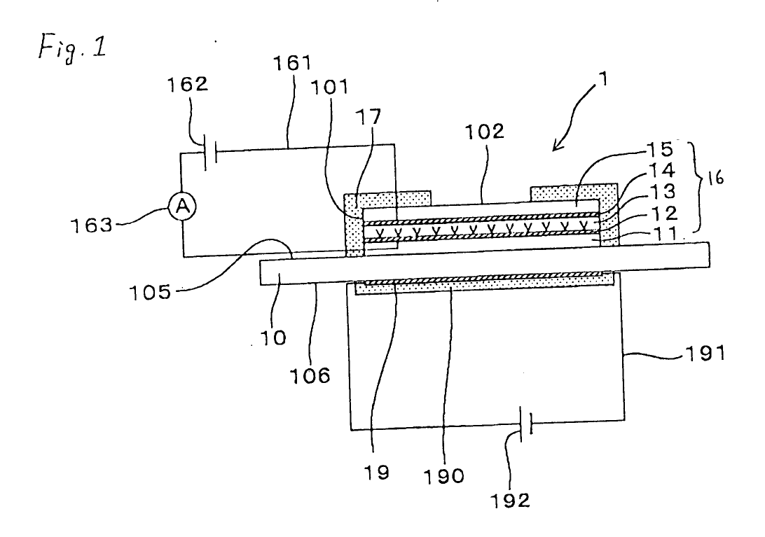

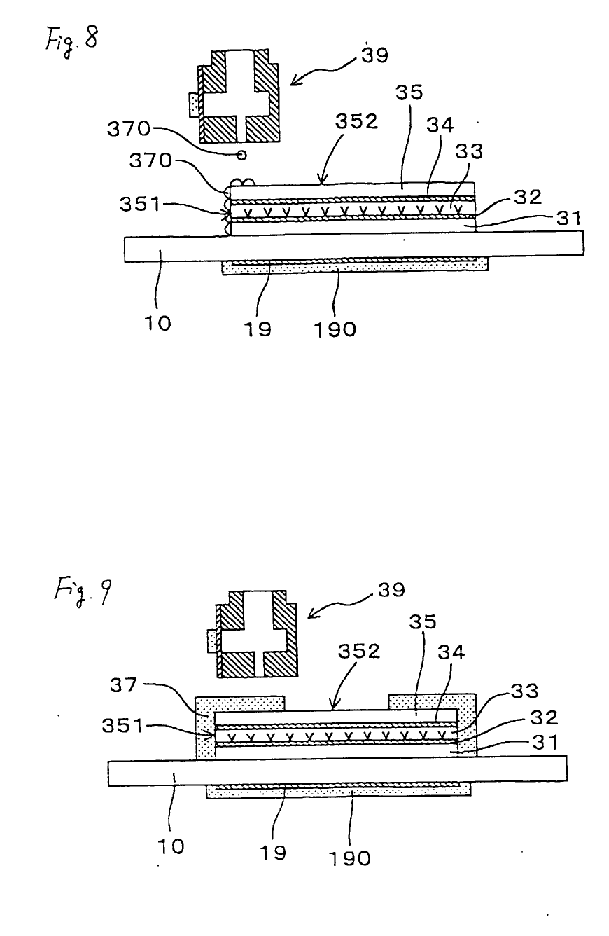

Reference is now made to FIGS. 1 to 9 to illustrate a method for manufacturing a gas sensor element of a layer-stacked or multilayered type according to the invention. It will be noted that throughout the drawings, like reference numerals indicate like parts or members.

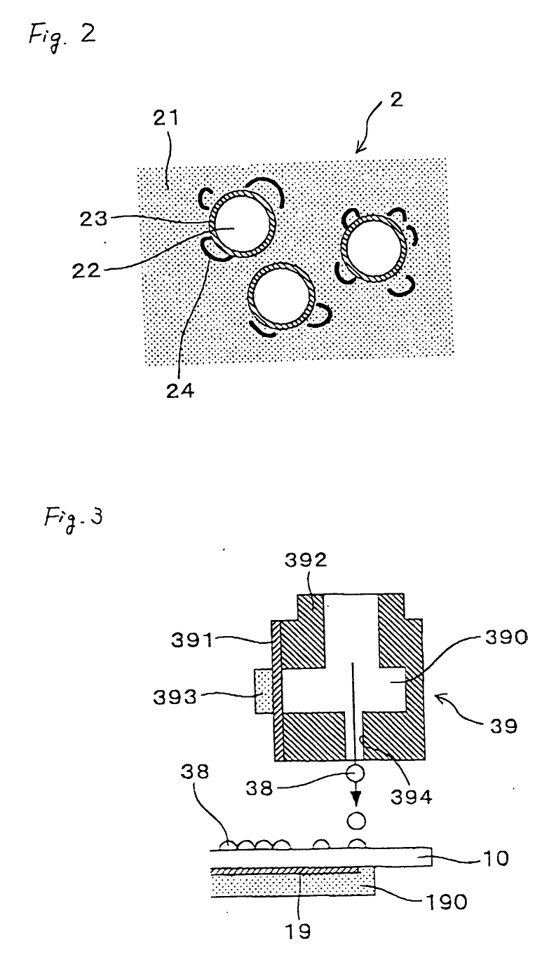

A multilayered gas sensor element according to this embodiment includes a substrate 10 having plural thin layers stacked thereon as shown in FIG. 1. These thin layers are each formed by subjecting a dispersion 2, which is obtained by dispersing nano-particles 22 along with a dispersant 23 in a dispersion medium 21 as is particularly shown in FIG. 2, to patterning to form a green or unsintered layer, followed by sintering.

The method is more particularly described below.

The gas sensor element 1 of this embodiment is illustrated with reference to FIG. 1. As shown in the figure, an alumina substrate 10 that is made of an insulative ceramic material has a surface 105, on which a first diffusion resistance layer 11, a first electrode layer 12, a first solid electrolyte layer 13, a second electrode layer 14 and a second diffusion resistance layer 15 are stacked in this order, thereby providing a sensing unit 1G The sensing unit 16 is covered with a dense, gas-impermeable, shielding layer 17 entirely at side faces 101 and partly on the upper surface 102 of the unit 16.

The substrate 10 has, at a back side 106 thereof, a heating element 19 capable of generating heat by application of electric current and a covering layer 190 covering the heating element 19 therewith.

A circuit 161 provided with a power supply 162 and an ammeter is connected to the first electrode layer 12 and the second electrode layer 14 as shown, and a circuit 191 having a power supply 192 is connected across the heating element 19.

In operation, a voltage is applied between the first and second electrode layers 12, 14, oxygen in a gas to be measured, which is taken in from a portion exposed to outer air through the second diffusion resistance layer of the sensing unit 16, is converted into oxygen ions at the second electrode 14. The oxygen ions move through the solid electrolyte layer 13 toward the first electrode layer 12 side. The resulting oxygen ion current is measured with the ammeter 163, thereby determining an oxygen concentration.

The element 1 of this embodiment has such a feature that the oxygen ion conductivity develops at the first solid electrolyte layer 13 only when the element reaches an element-activation temperature. Although the activation temperature may vary depending on the combination of types of materials used for the thin layers, it generally ranges from 500 to 700° C. To facilitate the temperature rise of the element, the heating element 19 capable of generating heat by application of electric current is provided at the back side 106 of the substrate 10 thereby constituting a heating unit.

In this embodiment, the first and second electrode layers 12, 14 are, respectively, mace of platinum. The solid electrolyte layer 13 is made, for example, of ittria-containing zirconia. Moreover, the first and second diffusion resistance layers 11, 15 are, respectively, made of porous alumina having a porosity of about 10%. For this purpose, ZrO₂ may be likewise usable.

According to the invention, the respective thin layers have substantially uniform thicknesses. More particularly, the first and second electrode layers 12, 14, respectively, have a thickness of 0.5 μm, the solid electrolyte layer 13 has a thickness of 5 μm, and the first and second diffusion resistance layers 11, 15, respectively, have a thickness of 10 μm.

The substrate is made of alumina and should be dense, gas-impermeable in nature. The shielding layer 17 is likewise made of alumina and should be formed as being dense and gas-impermeable.

The heating element 19 and the covering layer 190 are, respectively, made of insulative alumina. In the practice of the invention, the element 19 and the layer 190 are not formed by use of a dispersion containing nano-particles, but are formed according to a hitherto known paste printing technique.

The manner of fabricating the gas sensor element 1 shown in FIG. 1 is described in more detail.

Initially, dispersions for the respective thin layers are prepared.

A dispersion for the first and second electrode layers 12, 13 is prepared by dispersing about 10 wt % of nano-particles of Pt having a diameter of 5 to 20 nm in an aqueous medium along with a dispersant and a scavenger. The dispersant and the scavenger are usually used in equal amounts, so that nano-particles can be dispersed stably.

The state of the dispersion 2 is schematically shown in FIG. 2. As will be seen from the figure, individual nano-particles are covered on the surface thereof with the dispersant 23 and form discrete particles separate from one another. Moreover, the particle has a dispersant scavenger 24 gently joined to the layer surface of the dispersant 23 and individual particles are discretely dispersed as shown although this discrete dispersion is not essential in the practice of the invention.

According to a similar procedure, a dispersion for the first and second diffusion resistance layers 11, 15 is prepared by using a mixture of nano-particles made of alumina having a diameter of 10 to 50 nm and alumina Particles on the sub-micron order. The mixing ratio between the nano-particles and sub-micron particles may be appropriately controlled while taking a porosity of the resulting mixture into account.

Likewise, a dispersion for the first solid electrolyte layer 13 is prepared using nano-particles having a diameter of 10 to 40 nm and made of YSZ (yttria-stabilized zirconia).

Further, a dispersion used to form the shielding layer 17 by ink jet spraying is prepared by use of fine particles of alumina, like the case of the diffusion resistance layer. In this connection, however, in order that the shielding layer is formed as being more dense than the diffusion resistance layer, alumina particles used should be controlled in particle size within a range of 10 to 50 nm. Thus, nano particles of alumina are used.

Next, a Pt paste is screen printed on the surface 106 of the substrate 10 in a pattern, and sintered to provide a heater. Thereafter, an alumina paste is printed for coverage and sintered to provide a protective layer.

The thus sintered substrate 10 is subsequently applied with individual dispersions prepared above so that such an element unit as shown in FIG. 1 is obtained. The dispersion 2 as shown in FIG. 2 is subjected to ink jet printing on the surface 105 of the substrate 10 in a desired pattern to form a green layer. More particularly, as shown in FIG. 3, an injection port 390 of an ink jet head equipped with an ink reservoir 390 in the inside thereof and having a vibrator 391 and a drive piezo transducer is used to jet droplets 38 of a dispersion for the first diffusion resistance layer 11 against the substrate 10. To this end, the viscosity of the dispersion is favorably adjusted to 5 to 20 mPa. The droplets have a volume of 2 to 100 picoliters per unit droplet.

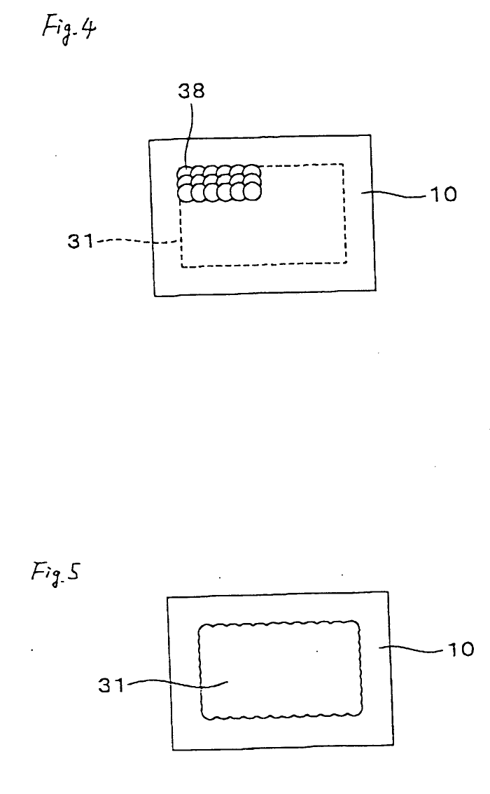

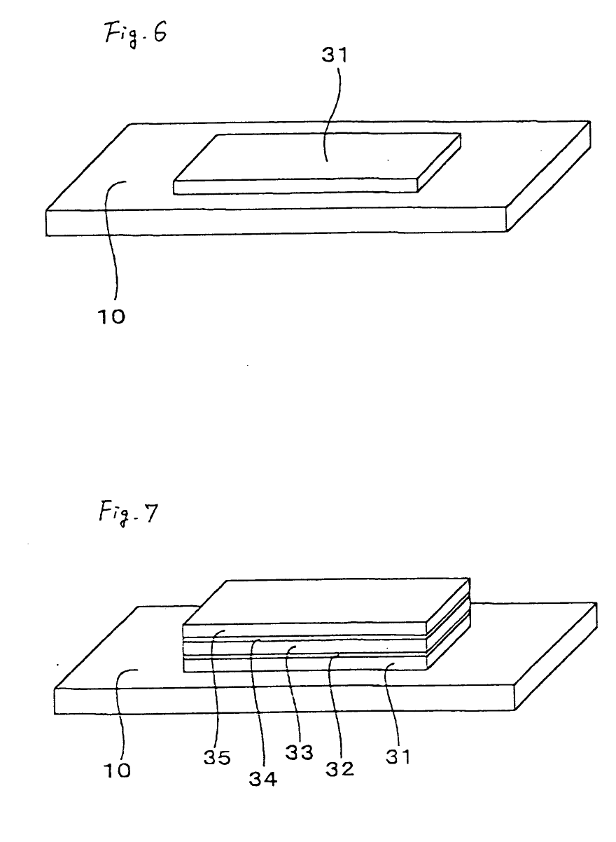

As shown in FIG. 4, the droplets 38 are successively dropped on an area or region where a thin layer is formed, thereby obtaining a green layer 31 of a desired pattern as is particularly shown in FIGS. 5 and 6. In this case, the green layer 31 is dried naturally. Thereafter, dispersions containing different types of materials, each in the form of nano particles, are successively applied onto the region or area where thin layers of intended types of materials are formed. It should be noted that the application of one dispersion should preferably be effected at least after natural drying of a previously formed layer. As a result, green layers 32, 33, 34, 35 are stacked on the first layer 31 as shown in FIG. 7.

After completion of the application of all the dispersions, droplets 370 of a dispersion for the shielding layer 17 are sprayed over side faces 351 and an upper surface 352 of the stacked green layers 31 to 35 in a desired pattern on the upper surface 352 to form a green layer 37.

Finally, the substrate 10 having the green layers 31 to 35 and 37 are sintered all at once in air at a temperature of 1000 to 1350° C. for 30 to 300 minutes in a manner as is known in the art. According to the above-stated procedure, a layer-stacked gas sensor 1 can be obtained.

Although the sintering is effected such that all the green layers are sintered at once in the above illustration, individual green layers may be sintered one by one after natural drying. More particularly, the green layer 31 may be formed and naturally dried, followed by sintering at a given temperature between 1000 to 1350° C. Thereafter, a dispersion for the green layer 32 is applied or coated onto the sintered layer 31 and sintered, followed by repeating the coating, natural drying and sintering procedures of the respective layers 33 to 35 and 37.

In the manufacturing method of the invention, dispersions 2 containing nano-particles 22 of different types of materials necessary for making the sensor unit 16 formed on the substrate 10 are, successively, applied in pattern thereby forming the sensor unit 16 including the first diffusion resistance film 11 and the like as shown in FIG. 1 This is advantageous over a known sputtering method in that a time required for the layer formation is much more reduced.

Further, because a dispersion 2 containing nano particles 22 of an intended type of material is used, a very thin layer or film having a thickness on the order of several micrometers can be readily formed. The nano particles themselves are sinterable at relatively low temperatures, thus contributing to cost-saving at the time of the manufacture.

The layer-stacked gas sensor element of this embodiment using the thin layers as illustrated hereinabove is accordingly made small in thickness, volume and heat capacity. This is advantageous in that relatively immediately after commencement of heating, the sensor element can reach a temperature of activation at which sensing of gas concentration can be initiated. The small volume of the sensor element enables a gas to be measured to arrive, for example, at the second electrode layer 14 in FIG. 1 from outside within a short time. This means that the sensor element is excellent in responsiveness or sensitivity.

Using a printing technique, the patterning of a dispersion 2 is not complicated, and thus, a green layer can be readily formed in a desired dimension. Hence, good dimensional accuracy is ensured.

The element of good dimensional accuracy leads to a good accuracy of measurement.

### Embodiment 2

A layer-stacked gas sensor element having a structure or arrangement different from that of Embodiment 1. More particularly, the element 1 of this embodiment is one which is able to measure a NOx concentration and has a two-cell arrangement.

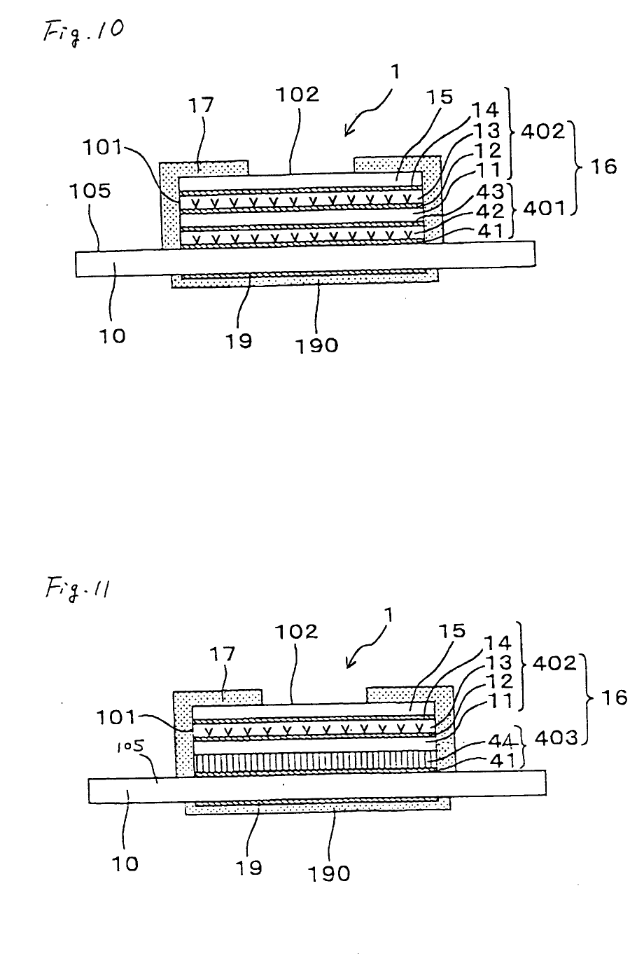

Reference is now made to FIG. 10, showing a cell 1 that has a two-cell arrangement as shown. The arrangement includes, on a surface 105 of a substrate that is opposite to a surface on which a heating element 19 and a covering layer 190 for the heating element 19, a third electrode film 41, a second solid electrolyte layer 42, a fourth electrode layer 43, a first diffusion resistance layer 11, a first electrode layer 12, a first solid electrolyte layer 13, a second electrode layer 14 and a second diffusion resistance layer 15 arranged in this order, thereby providing a sensing unit 16.

A dense, gas-impermeable shielding layer 17 is formed entirely on side faces 101 and partly on the upper surface 102 of the sensing unit 16.

In this embodiment, the first and second electrode layers 12, 14 are, respectively, made of platinum, the first solid electrolyte layer 13 is made of yttria-containing zirconia, and the first and second diffusion resistance layers 11,15 are, respectively, made of porous alumina (having a porosity of about 10%).

The third electrode 41 is made of an electrode material capable of reducing NOx, e.g. a Pt—Au alloy, and the fourth electrode layer 43 is made, for example, of Pt. The second solid electrolyte layer 42 is made, for example, yttria-containing zirconia, like the first solid electrolyte layer 13.

The sensing unit 16 of this element 1 according to this embodiment includes a NOx measuring cell 401 including the third electrode 41, second solid electrolyte layer 452 and fourth electrode layer 43, and an oxygen pump cell 402 including the first diffusion resistance layer 11, first electrode layer 12, first solid electrolyte layer 13, second electrode layer 14 and second diffusion resistance layer 15.

The oxygen pump cell 402 works as follows. If a gas to be measured is in an oxygen-lean condition, a voltage is so applied between the first and second electrodes that an oxygen ion current passes from the first electrode layer 12 toward the second electrode layer 14. On the contrary, if a gas to be measured is in an oxygen-rich condition, the application of a voltage between the first and second electrodes is such that an oxygen ion current passes from the second electrode layer 14 toward the first electrode layer 12. In this way, the atmosphere in the first diffusion resistance layer 11 is invariably held constant with respect to the concentration of oxygen.

NOx contained in the gas to be measured is passed through the oxygen pump cell 402 and arrives at the fourth electrode layer 43 at which this NOx is reduced and decomposed into oxygen ions and nitrogen ions. This causes a potential difference to occur between the third electrode layer 41 and the fourth electrode layer 43. Measuring the potential difference leads eventually to determination of a NOx concentration.

The gas sensor element 1 having such a multicell arrangement as set out above can be fabricated in the same manner as in the first embodiment.

With the two-cell or multicell type, individual element layers are formed as very thin, so that the total element thickness can be significantly reduced. To realize a small layer thickness as a total may lead to easy fabrication of a multicell sensor element.

More particularly, when a sensor element is fabricated by conventional techniques using, for example, a doctor blade, individual layers are very liable to be thicker than those attained by the present invention, and may become poor in responsiveness and ultra-early development of sensitivity or activation of a sensor element. In this sense, the sensor element of the invention having such an arrangement as shown in FIG. 10 is advantageously good with respect to the responsiveness and the ultra-early development.

### Embodiment 3

A layer-stacked gas sensor having an arrangement different from that of Embodiment 1 is described with reference to FIG. 11.

An element 1 of this embodiment is shown in FIG. 11 and is one which ahs a two-cell arrangement and is able to measure a concentration of CO. Like Embodiment 2, a sensing unit 16 is formed on a surface 105 of a substrate 10 opposite to a sur:ace on which a heating element 19 and a covering layer 190 for the heating element 19 are formed. The sensing unit 16 includes a third electrode layer 41, a semiconductor layer 44, a first diffusion layer 11, a first electrode layer 12, a first solid electrolyte layer 13, a second electrode layer 14, and a second diffusion resistance layer 15 stacked on the surface 105 in this order.

Like the foregoing embodiments, a dense, gas-impermeable shielding layer 17 is formed entirely on side surfaces 101 and partly on the upper surface 102 of the sensing unit 16.

For instance, the first and second electrode layers are, respectively, made of platinum, the solid electrolyte layer 13 is made of yttria-containing zirconia, and the first and second diffusion resistance layers 11, 15 are, respectively, made of porous alumina (having a porosity of about 10%).

The third electrode layer is made, for example, of platinum, the semiconductor layer 44 is made of semiconductive oxide particles, e.g. SnO₂. In order to detect CO, a small amount of a catalyst such as Pt, Pd or the like is added to the layer of the semiconductive oxide.

The sensing unit 16 of the element 1 according to this embodiment includes a CO measuring cell 403 made of the third electrode layer 41 and the semiconductor layer 44 and an oxygen pump cell 402 made of the first diffusion resistance layer 11, first electrode layer 12, first solid electrolyte layer 13, second electrode layer 14 and second diffusion resistance layer 15.

In operation, the pump cell 402 so functions as to be illustrated in Embodiment 1 i.e. an atmosphere within the first diffusion resistance layer 11 is kept constant with respect to the concentration of oxygen.

CO contained in a gas to be measured passes through the oxygen pump cell 402 and arrives at the semiconductor layer 44 wherein CO is oxidized into CO₂. This enables one to determine a variation in electric resistance in a circuit connecting the third electrode layer 41 and the semiconductor layer 44 therebetween. From the value of the variation, a concentration of CO can be calculated.

The sensor element of this embodiment as is particularly shown in FIG. 11 can be fabricated in the same way as in Embodiment 1.

1. A method for manufacturing a multilayered gas sensor element including plural thin layers, the method comprising applying, onto a substrate in a pattern, a dispersion of nano-particles of a desired type of material in a dispersion medium along with a dispersant to provide a thin green layer of the nano-particles, repeating the above procedure using a different type of material until a desired number of green layers necessary for making a sensing unit on the substrate are stacked on the substrate, and sintering the stacked green layers.

2. The method according to claim 1, wherein said stacked green layers are sintered simultaneously.

3. The method according to claim 2, wherein the desired number of green layers are successively formed after drying of a preceding green layer.

4. The method according to claim 1, wherein the desired number of green layers are formed and sintered one by one thereby obtaining totally sintered layers.

5. The method according to claim 1, wherein the nano-particles contained in the desired number of green layers have a size ranging from 3 nm to 50 nm.

6. The method according to claim 1, wherein said sensing unit includes a first diffusion resistance layer, a first electrode film, a solid electrolyte layer, a second electrode layer and a second diffusion resistance layer stacked on said substrate in this order, each layer being made of sintered nano-particles.

7. The method according to claim 6, wherein said sensing unit is covered at side surfaces thereof with a dense, gas impermeable, shielding layer.

8. The method according to claim 1, wherein said sensing unit includes a third electrode layer, a second solid electrolyte layer a fourth electrode layer, a first diffusion resistance layer, a first electrode layer, a first solid electrolyte layer, a second electrode layer and a second diffusion resistance layer stacked on said substrate in this order wherein said third electrode layer, said second solid electrolyte layer and said fourth electrode layer serve, in combination, as a NOx measuring cell, and said first diffusion resistance layer, said first electrode layer, said first solid electrolyte layer, said second electrode layer and said second diffusion resistance layer serve, in combination, as an oxygen pump cell wherein said sensing element serves to sense NOx gas.

9. The method according to claim 8, wherein said sensing unit is covered at side surfaces thereof with a dense, gas impermeable, shielding layer.

10. The method according to claim 1, wherein said sensing unit includes a third electrode layer, a semiconductor layer, a first diffusion resistance layer, a first electrode layer, a solid electrolyte layer, a second electrode layer and a second diffusion resistance film stacked on said substrate in this order wherein said third electrode layer and said semiconductor layer serve, in combination, as a CO measuring cell, and said first diffusion resistance layer, said first electrode layer, said solid electrolyte layer, said second electrode layer and said second diffusion resistance layer serve, in combination, as an oxygen pump cell wherein said sensing element serves to sense CO gas.

11. The method according to claim 10, wherein said sensing unit is covered at side surfaces thereof with a dense, gas impermeable, shielding layer.
